(19) United States
(12) Patent Application Publication
(10) Pub. No.: US 2016/0377199 A1
(43) Pub. Date: Dec. 29, 2016

(54) UNDERWATER PIPE ASSEMBLY AND METHOD FOR ASSEMBLING UNDERWATER PIPES

(71) Applicants: Ian Larsen, Nicosia (CY); Chen-Shan KUNG, Taipei City (TW); Yuan-Jui LU, Taipei City (TW)

(72) Inventors: Ian Larsen, Nicosia (CY); Chen-Shan KUNG, Taipei City (TW); Yuan-Jui LU, Taipei City (TW)

(21) Appl. No.: 15/182,418

(22) Filed: Jun. 14, 2016

(30) Foreign Application Priority Data
Jun. 24, 2015 (TW) 104120330

(51) Int. Cl. F16L 1/26; F16L 19/025; F16L 19/02

(52) U.S. Cl. CPC F16L 1/26; F16L 19/0206; F16L 19/025; F16L 19/0231

(57) ABSTRACT

An underwater pipe assembly includes a first pipe having a first flange, a second pipe having a second flange, and a plurality of connecting units clamped around the first and second flanges. Each connecting unit includes a clamp seat disposed on and covering the first and second flanges and having a first clamping portion, a first pad disposed between the first clamping portion and the first flange, a second pad disposed on the second flange, and a fastener operably and movably mounted to the clamp seat and having a second clamping portion facing the second pad. The first clamping portion clamps the first pad against the first flange and the second clamping portion clamps the second pad against the second flange when the fastener is operated.

### CROSS-REFERENCE TO RELATED APPLICATION

This application claims priority to Taiwanese Application No. 104120330, filed on Jun. 24, 2015.

### FIELD

The disclosure relates to a pipe assembly, and more particularly to an underwater pipe assembly and a method for assembling underwater pipes.

### BACKGROUND

As shown in FIG. 1, a conventional underwater pipe assembly used for pumping seawater includes two adjacent pipes 1 and a connector apparatus. Each pipe 1 has a pipe body 101 extending along a longitudinal axis, and two annular flanges 102 projecting radially, outwardly and respectively from two opposite ends of the pipe body 101. The flange 102 at one end of one of the pipes 1 abuts against the flange 102 at a corresponding end of the adjacent pipe 1. The connector apparatus includes a plurality of angularly spaced-apart connecting units 2 disposed around the abutted flanges 102 of the adjacent pipes 1. Each of the connecting units 2 includes two clamp plates 201 respectively abutting against the flanges 102 of the adjacent pipes 1 that abut against each other, and a fastener 202 securing the clamp plates 201 so as to clamp the abutted flanges 102 of the adjacent pipes 1 therebetween. By using the connector apparatus 2, the use length of the pipes 1 may be extended.

However, when a fastening force of the fastener 202 to secure the two clamp plates 201, each having an I-cross section relative to the longitudinal axis, is excessive, the clamp plates 201 are likely to deviate such that inner portions thereof move away from each other and outer portions thereof move toward each other. This causes the connecting effect of the connector apparatus to be poor which in turn may cause leakage of seawater during pumping.

### SUMMARY

Therefore, an object of the disclosure is to provide an underwater pipe assembly that can alleviate the drawbacks of the prior art.

Another object of the disclosure is to provide a method for assembling underwater pipes.

According to one aspect of the disclosure, an underwater pipe assembly includes a first pipe, a second pipe and a connector apparatus.

The first pipe includes a first pipe body extending along a longitudinal axis, and an annular first flange projecting radially and outwardly from a peripheral end of the first pipe body and having a first end surface and a second end surface opposite to the first end surface.

The second pipe includes a second pipe body extending along the longitudinal axis, and an annular second flange projecting radially and outwardly from a peripheral end of the second pipe body and having a first end surface that abuts against the first end surface of the first flange, and a second end surface opposite to the first end surface of the second flange along the longitudinal axis.

The connector apparatus includes a plurality of connecting units clamped around the first and second flanges. Each of the connecting units includes a clamp seat disposed on and covering the first and second flanges and having a first clamping portion, a first pad disposed between the first clamping portion and the second end surface of the first flange, a second pad disposed on the second end surface of the second flange, and a fastener operably and movably mounted to the clamp seat and having a second clamping portion facing the second pad. The first clamping portion presses the first pad against the second end surface of the first flange and the second clamping portion presses the second pad against the second end surface of the second flange when the fastener is operated.

According to another aspect of the disclosure, a method for assembling underwater pipes includes the steps of:

(A) preparing a first pipe, a second pipe and a connector apparatus, the first pipe including a first pipe body extending along a longitudinal axis, and an annular first flange projecting radially and outwardly from a peripheral end of the first pipe body and having a first end surface, and a second end surface opposite to the first end surface, the second pipe including a second pipe body extending along the longitudinal axis, and an annular second flange projecting radially and outwardly from a peripheral end of the second pipe body and having a first end surface and a second end surface opposite to the first end surface of the second flange along the longitudinal axis, the connector apparatus including a plurality of connecting units, each of the connecting units including a clamp seat having a first clamping portion, a first pad, a second pad, and a fastener having a second clamping portion;

(B) abutting the first end surfaces of the first and second flanges against each other;

(C) disposing the connecting units around the first and second flanges such that the clamp seats of the connecting units cover the first and second flanges, the first pads of the connecting units surround the second end surface of the first flange, the second pads of the connecting units surrounding the second end surface of the second flange, the first clamping portions of the clamp seats respectively face the first pads, and the fasteners of the connecting units are respectively connected to the clamp seats and respectively face the second pads; and

(D) operating the fasteners of the connecting units such that the second clamping portions of the fasteners press and position the second pads against the second end surface of the second flange, and the first clamping portions of the clamp seats of the connecting units press and position the first pads against the second end surface of the first flange, thereby clamping the first and second flanges between the first and second clamping portions.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary side view of a conventional underwater pipe assembly;

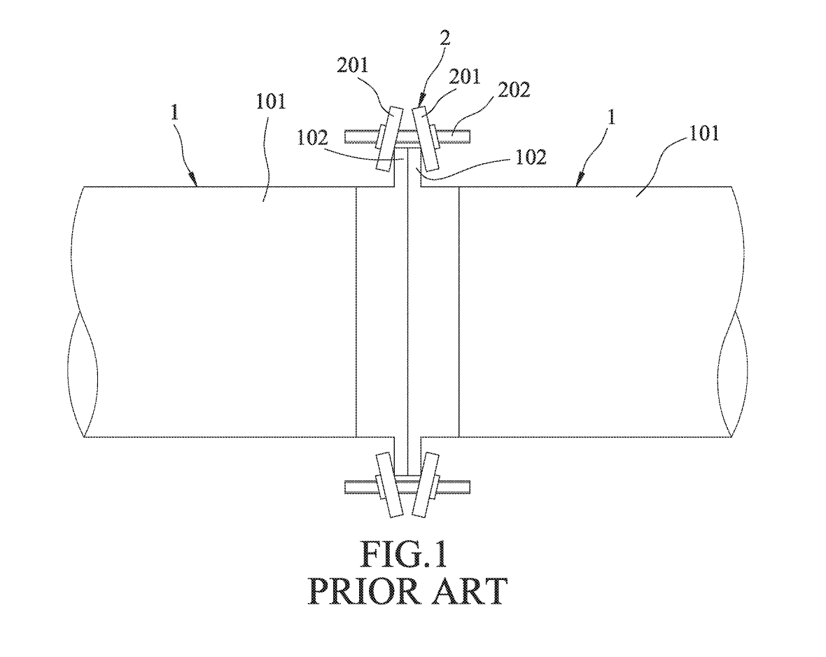

FIG. 2 is a fragmentary sectional side view of an embodiment of an underwater pipe assembly according to the disclosure;

FIG. 3 is a sectional view of the embodiment taken along line III-III of FIG. 2;

FIG. 4 is an enlarged fragmentary sectional side view of the embodiment; and

FIG. 5 is a fragmentary perspective view of the embodiment.

### DETAILED DESCRIPTION

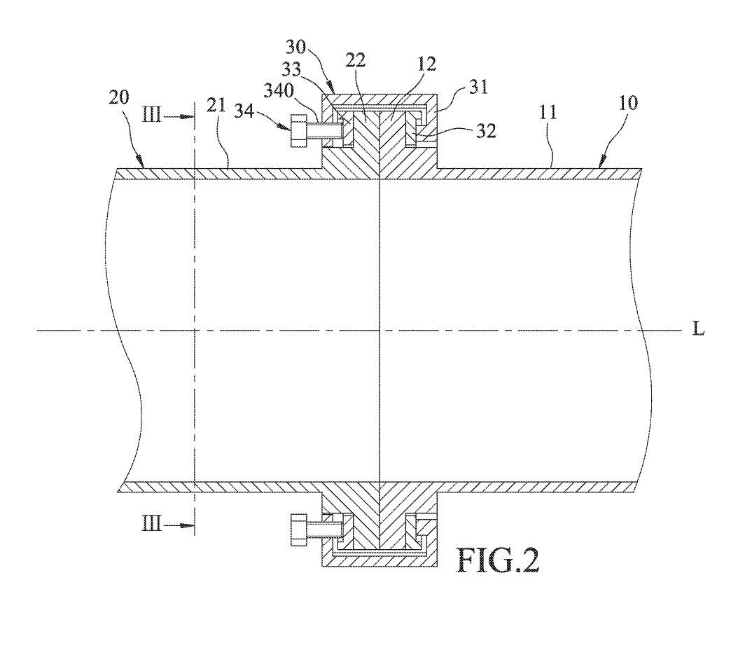

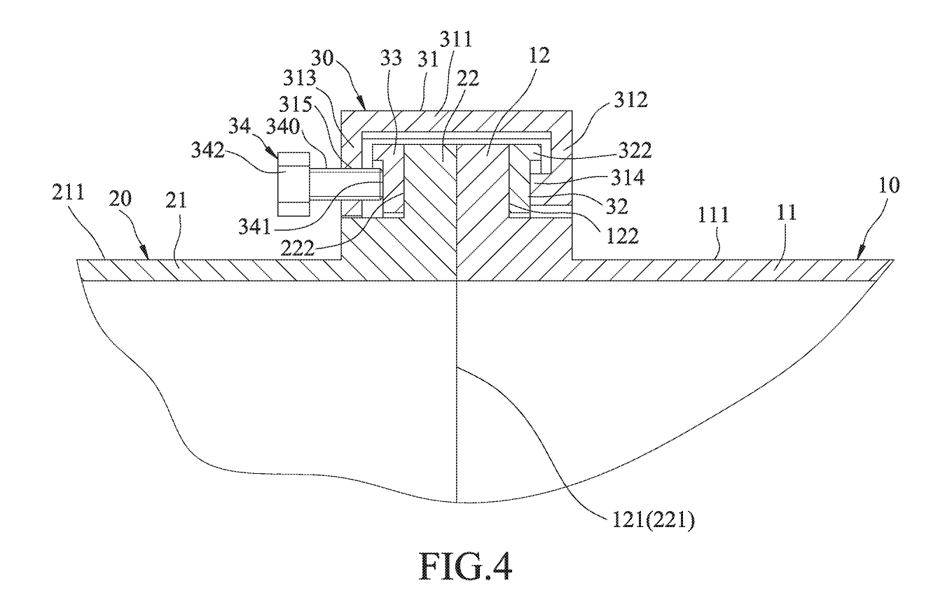

Referring to FIGS. 2 to 5, an embodiment of a large-diameter underwater pipe assembly according to the disclosure is shown to include a first pipe 10, a second pipe 20 and a connector apparatus.

The first pipe 10 includes a first pipe body 11 extending along a longitudinal axis (L) and having an annular first flange 12 projecting radially and outwardly from a peripheral end of the first pipe body 11 and having a first end surface 121 and a second end surface 122 opposite to the first end surface 121 along the longitudinal axis (L).

The second pipe 20 includes a second pipe body 21 extending along the longitudinal axis (L) and having an annular second flange 22 projecting radially and outwardly from a peripheral end of the second pipe body 21 and having a first end surface 221 that abuts against the first end surface 121 of the first flange 12, and a second end surface 222 opposite to the first end surface 221 of the second flange 22 along the longitudinal axis (L).

The connector apparatus includes a plurality of connecting units 30 clamped around the first and second flanges 12, 22. Each of the connecting units 30 includes a clamp seat 31 disposed on and covering the first and second flanges 12, 22, a first pad 32, a second pad 33, and a fastener 34.

The clamp seat 31 of each of the connecting units 30 has an inverted U-shaped cross section including a first lateral plate 312 facing the second end surface 122 of the first flange 12, a second lateral plate 313 facing the second end surface 222 of the second flange 22, an intermediate plate 311 interconnecting the first and second lateral plates 312, 313, and a first clamping portion 314 that is configured as a protrusion protruding from an end portion of the first lateral plate 312 toward the first pad 33. The second lateral plate 313 has a threaded hole 315 formed in proximity to an end thereof.

The first pad 32 is disposed between the first clamping portion 314 and the second end surface 122 of the first flange 12, and has an inverted L-shaped cross section relative to the longitudinal axis (L).

The second pad 33 is disposed between the second lateral plate 313 and the second end surface 222 of the second flange 22, and has an inverted L-cross section relative to the longitudinal axis (L).

The fastener 34 is threadedly engaged to the threaded hole 315 and is opposite to the first clamping portion 314. In this embodiment, the fastener 34 is configured as a threaded bolt that includes a shank 340 having a second clamping portion 341, and a head 342 opposite to the second clamping portion 341 and located externally of the second lateral plate 313.

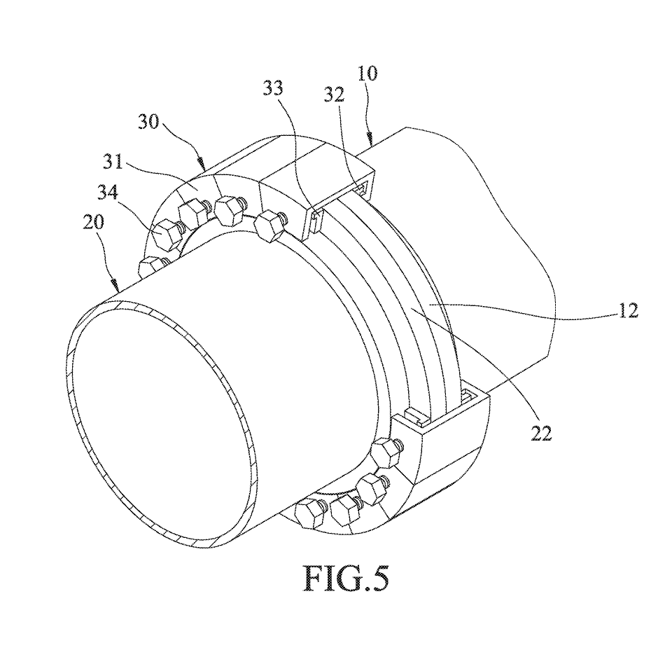

During assembly, the clamp seat 31 of each connecting unit 30 is first disposed on the first and second flanges 12, 22 to cover the same, after which the first pad 32 and the second pad of each connecting unit 30 are respectively disposed on the second end surfaces 122, 222 of the first and second flanges 12, 22. Next, the clamp seat 31 is shifted along the longitudinal axis (L) to abut the first clamping portion 314 against the first pad 32. Afterwards, the head 342 of the fastener 34 is operated to advance the fastener 34 toward the second flange 22 until the second clamping portion 341 presses the second pad 33 to abut against the second end surface 222 of the second flange 12 and the first clamping portion 314 presses the first pad 32 to abut against the second end surface 122 of the first flange 12, thereby clamping the first and second flanges 12, 22 between the first and second clamping portions 314, 341. Hence, the first and second flanges 12, 22 can be stably clamped using the connecting units 30, so that the first and second pipes 10, 20 can be stably connected to each other (see FIG. 5).

The advantages of the underwater pipe assembly of the disclosure reside in that, because of the configuration of the first clamp seats 31, the adjustable movement of the fastener 34 and the first and second pads 32, 33 respectively abutting against the second end surfaces 122, 222 of the first and second flanges 12, 22, a large clamping area is achieved, so that the efficiency of the connector apparatus of the disclosure can be ensured, and the occurrence of leakage during pumping of seawater can be avoided.

A method for assembling large-diameter underwater pipes of this disclosure is described with reference to FIGS. 2 to 5, and includes the following steps:

Step 1: preparing the first pipe 10, the second pipe 20 and the connector apparatus;

Step 2: abutting the first end surfaces 121, 221 of the first and second flanges 11, 12 of the first and second pipes 10, 20 against each other;

Step 3: disposing the connecting units 30 of the connector apparatus around the first and second flanges 11, 12 such that the clamp seats 31 of the connecting units 30 cover the first and second flanges 11, 12, the first pads 32 of the connecting units 30 surround the second end surface 122 of the first flange 12, the second pads 33 of the connecting units 30 surround the second end surface 222 of the second flange 22, the first clamping portions 314 of the clamp seats 31 respectively face the first pads 32, and the fasteners 34 of the connecting units 30 are respectively connected to the clamp seats 31 and respectively face the second pads 33;

Step 4: operating the heads 342 of the fasteners 34 of the connecting units 30 to advance the fasteners 34 toward the second flange 22 until the second clamping portions 341 of the fasteners 34 press and position the second pads 33 against the second end surface 222 of the second flange 22, and the first clamping portions 314 of the clamp seats 31 of the connecting units 30 press and position the first pads 32 against the second end surface 122 of the first flange 12, thereby clamping the first and second flanges 12, 22 between the first and second clamping portions 314, 341.

By using the aforesaid steps, the first and second pipes 10, 20 can be stably connected to each other through the connecting units 30. Further, the components of the disclosure are easy to manufacture and assemble. Hence, not only is the cost of the disclosure can be minimized, the structural strength thereof can be enhanced as well.

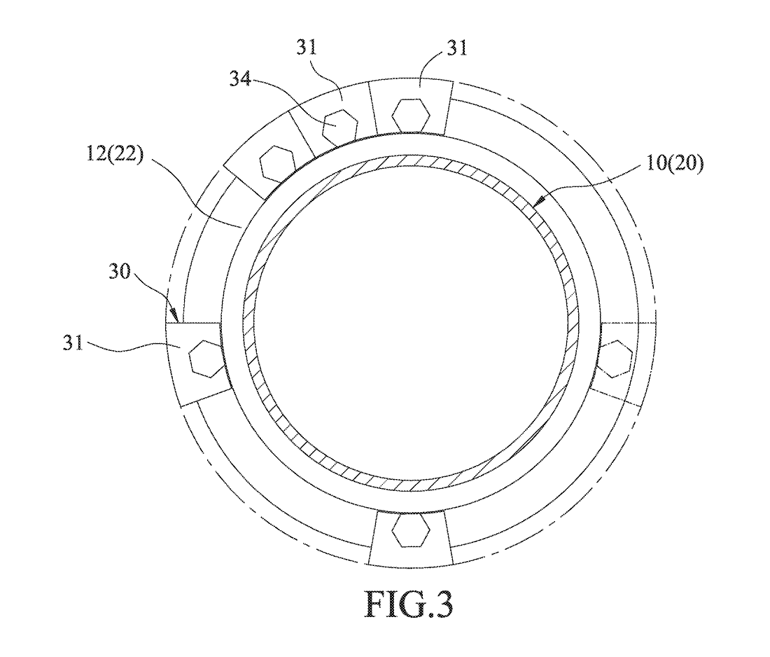

It is worth to mention herein that the clamp seats 31 of the connecting units 30 may be individually disposed on the first and second flanges 12, 22 in an angularly spaced apart manner (see left and lower part of FIG. 3) or may be grouped and arranged in an angularly spaced apart manner (see upper part of FIG. 3). A similar connecting effect may be achieved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An underwater pipe assembly comprising:
a first pipe including a first pipe body extending along a longitudinal axis, and an annular first flange projecting radially and outwardly from a peripheral end of said first pipe body and having a first end surface and a second end surface opposite to said first end surface along the longitudinal axis;
a second pipe including a second pipe body extending along the longitudinal axis, and an annular second flange projecting radially and outwardly from a peripheral end of said second pipe body and having a first end surface that abuts against said first end surface of said first flange, and a second end surface opposite to said first end surface of said second flange along the longitudinal axis (L); and
a connector apparatus including a plurality of connecting units clamped around said first and second flanges, each of said connecting units including a clamp seat disposed on and covering said first and second flanges and having a first clamping portion, a first pad disposed between said first clamping portion and said second end surface of said first flange, a second pad disposed on said second end surface of said second flange, and a fastener operably and movably mounted to said clamp seat and having a second clamping portion facing said second pad, said first clamping portion pressing said first pad against said second end surface of said first flange and said second clamping portion pressing said second pad against said second end surface of said second flange when said fastener is operated.

2. The underwater pipe assembly as claimed in claim 1, wherein said clamp seat of each of said connecting units further has a first lateral plate facing said second end surface of said first flange, a second lateral plate facing said second end surface of said second flange, and an intermediate plate interconnecting said first and second lateral plates, said first clamping portion being configured as a protrusion that protrudes from an end portion of said first lateral plate toward said first pad, said second lateral plate having a threaded hole formed in proximity to an end thereof for threaded connection with said fastener, said fastener being configured as a threaded bolt that includes a shank having said second clamping portion, and a head opposite to said second clamping portion and located externally of said second lateral plate.

3. A method of assembling underwater pipes, comprising the steps of:
(A) preparing a first pipe, a second pipe and a connector apparatus, the first pipe including a first pipe body extending along a longitudinal axis, and an annular first flange projecting radially and outwardly from a peripheral end of the first pipe body and having a first end surface, and a second end surface opposite to the first end surface, the second pipe including a second pipe body extending along the longitudinal axis, and an annular second flange projecting radially and outwardly from a peripheral end of the second pipe body and having a first end surface and a second end surface opposite to the first end surface of the second flange along the longitudinal axis, the connector apparatus including a plurality of connecting units, each of the connecting units including a clamp seat having a first clamping portion, a first pad, a second pad, and a fastener having a second clamping portion;
(B) abutting the first end surfaces of the first and second flanges against each other;
(C) disposing the connecting units around the first and second flanges such that the clamp seats of the connecting units cover the first and second flanges, the first pads of the connecting units surround the second end surface of the first flange, the second pads of the connecting units surround the second end surface of the second flange, the first clamping portions of the clamp seats respectively face the first pads, and the fasteners of the connecting units are respectively connected to the clamp seats and respectively face the second pads; and
(D) operating the fasteners of the connecting units such that the second clamping portions of the fasteners press and position the second pads against the second end surface of the second flange, and the first clamping portions of the clamp seats of the connecting units press and position the first pads against the second end surface of the first flange, thereby clamping the first and second flanges between the first and second clamping portions.
